(19) United States
(12) Patent Application Publication
(10) Pub. No.: US 2014/0150055 A1
(43) Pub. Date: May 29, 2014

(54) DATA REFERENCE SYSTEM AND APPLICATION AUTHENTICATION METHOD

(71) Applicant: FUJITSU LIMITED, Kawasaki-shi (JP)

(72) Inventor: Akio SHIMONO, Yokohama (JP)

(73) Assignee: FUJITSU LIMITED, Kawasaki-shi (JP)

(21) Appl. No.: 14/036,663

(22) Filed: Sep. 25, 2013

(30) Foreign Application Priority Data
Nov. 26, 2012 (JP) 2012-258043

(51) Int. Cl. G06F 21/30

(52) U.S. Cl. CPC G06F 21/30
USPC 726/2

(57) ABSTRACT

A server system includes an application server and a data server. The application server includes an application authentication unit that authenticates an application on the basis of information that has been received from a communication terminal and that is related to the application included in the terminal and includes a token issuing unit that issues, when the legitimacy of the application has been authenticated, signature information that includes server information that indicates a server that stores therein data accessed by the application. The data server includes an authentication unit that determines, on the basis of the signature information received from the communication terminal, whether the server information included in the signature information indicates the data server and includes a control unit that permits the application in the communication terminal to access the data when the server information indicates the data server.

### CROSS-REFERENCE TO RELATED APPLICATION

This application is based upon and claims the benefit of priority of the prior Japanese Patent Application No. 2012-258043, filed on Nov. 26, 2012, the entire contents of which are incorporated herein by reference.

### FIELD

The embodiments discussed herein are directed to a data reference system and an application authentication method.

### BACKGROUND

Users use services provided via a network, such as the Internet. The users access, via the network, the services managed by the side that provides the services (hereinafter, referred to as the “service provider side”).

There is a known method in which users directly access services via, for example, browsers. Data on each user is managed by the service provider side. When a user uses a service provided via the network, the service provider side provides the service in accordance with the content included in information, such as access permission, that is individually set on the basis of the data on the user.

Furthermore, there is a known method in which users access services via applications. With this method, because applications are not always created on the service provider side, the service provider side performs, in addition to authentication with respect to permission for a user to connect to a service by using an application, authentication with respect to permission to access the application.

With the authentication with respect to application access permission, when the service provider side permits access from the application, the service provider side issues an ID and a password that identify the application. Then, the service provider side performs authentication by using this ID and password, which identify the application when a user connects to the service via the application. After the completion of the authentication, the service provider side issues a token and then the application accesses, by using the token, the service in accordance with operations performed by the user. This type of authentication with respect to an application is known as OAuth (for example, Patent Document 1).

However, in general, because services need to always be used in combination with data that is created in accordance with the services, the service provider side manages the data. Consequently, even though the data is itself derived from a user, the user is not able to freely use data related to a service, is not able to conceal data from the service provider, and is not able to reliably dispose of data.

Consequently, with the method in which the service provider side manages data, even though the data is, for example, input or edited by a user, it is difficult to use or access the data from another service that is provided via the network. Furthermore, even if access from another service is permitted, it is difficult to use the data from that service while sufficiently maintaining the security of that service and the data from that service.

Accordingly, there is a technology that, by separating services from data, enables users to control and centrally manage their own data by themselves (for example, Patent Document 2).

Patent Document 1: Japanese Laid-open Patent Publication No. 2012-194722

Patent Document 2: International Publication Pamphlet No. WO 2012077223

However, if, by separating services from data, users control and centrally manage their own data by themselves, the application that uses the service still needs to access, in order to access the data, the location in which the data is stored in addition to accessing the service provider source. With the method in which the service provider side manages data, there is only a need for an application to deliver authentication related information to only the service provider side. However, if the service provider source is separated from the location in which the data is stored, the authentication related information needs to be delivered to both the service provider source and the location in which the data is stored.

Furthermore, if authentication related information on an application leaks, with the method of managing data on the service provider side, misuse can be prevented by the service provider side taking action. However, if the service provider source is separated from the location in which the data is stored, the effect due to the leakage is great.

Consequently, for example, if authentication related information on an application leaks into a data store location that is maliciously created, there is a problem in that an illegitimate application is created by using the authentication related information on the application. The data store location mentioned here is referred to as, for example, a “data store”.

In the following, this problem will be described with reference to FIG. 13. FIG. 13 is a schematic diagram illustrating a problem in which authentication related information on an application leaks into a data store that is created with malicious intent. As illustrated in FIG. 13, by separating the service from the data store, users U1 and U2 can control and centrally manage their own data by themselves. Here, it is assumed that a data store 1 is a normal data store, the user U2 is a malicious user, and information obtained by a data store 2 can be used.

If the malicious user U2 accesses the malicious data store 2 by using an application A, the application A performs, on the malicious data store 2, authentication by using the ID and the password that identify the application A. At this point, the application A uses, as the authentication related information, the ID and the password that identify the application A.

Consequently, the data store 2 can create an illegitimate application Aₘ by using the ID and the password that identify the application A. If the application Aₘ is created, because the application Aₘ can use the authentication related information on the application A to access another data store or a service, the application Aₘ can pretend to be the application A. In other words, this state in which authentication related information on the application A can be obtained via the data store is undesirable in terms of security.

In contrast, in a case in which the service provider side manages data, because the access destination of an application is only a service and because the subject service authenticates the application, there is no occurrence of the state, in a normal use state, in which the authentication related information on the application is used by a person other than the service provider. Furthermore, because the authentication related information on the application is only used for the subject service, the service provider side can cope with the leakage of authentication related information.

### SUMMARY

According to an aspect of an embodiment, a data reference system includes a first information processing apparatus and a second information processing apparatus. The first information processing apparatus includes an authentication unit and an issuing unit. The authentication unit authenticates, when an access is received that is made via an application, the legitimacy of the application on the basis of information related to the application. The issuing unit issues, when the legitimacy of the application has been authenticated, signature information that includes processing unit information that indicates an information processing apparatus that stores therein data that is accessed by the application. The second information processing apparatus includes a determining unit and a control unit. The determining unit determines, when an access that includes the signature information is received via the application, whether the processing unit information included in the signature information indicates the second information processing apparatus. The control unit permits, when the processing unit information is associated with the second information processing apparatus, the application to access the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the overall configuration of a server system according to a first embodiment;

FIG. 2 is a schematic diagram illustrating an example of the content of an application authentication token;

FIG. 3 is a schematic diagram illustrating an example of the content of a data access token;

FIG. 4 is a flowchart illustrating the flow of a process performed on the terminal device side according to the first embodiment;

FIG. 5 is a flowchart illustrating an application authentication process performed by an application server according to the first embodiment;

FIG. 6 is a flowchart illustrating the authentication process performed by the data server according to the first embodiment;

FIG. 7 is a block diagram illustrating the overall configuration of a server system according to a second embodiment;

FIG. 8 is a flowchart illustrating the flow of a process performed on the terminal device side according to the second embodiment;

FIG. 9 is a flowchart illustrating the flow of an authentication process performed by a data server according to the second embodiment;

FIG. 10 is a block diagram illustrating the overall configuration of a server system according to a third embodiment;

FIG. 11 is a flowchart illustrating the flow of a process performed on the terminal device side according to a third embodiment;

FIG. 12 is a flowchart illustrating the flow of an application authentication process performed by an application server according to the third embodiment; and

FIG. 13 is a schematic diagram illustrating a problem in which authentication related information on an application leaks into a data store that is created with malicious intent.

### DESCRIPTION OF EMBODIMENTS

Preferred embodiments of the present invention will be explained with reference to accompanying drawings. The present invention is not limited to the embodiments.

### [a] First Embodiment

### Configuration of a Server System

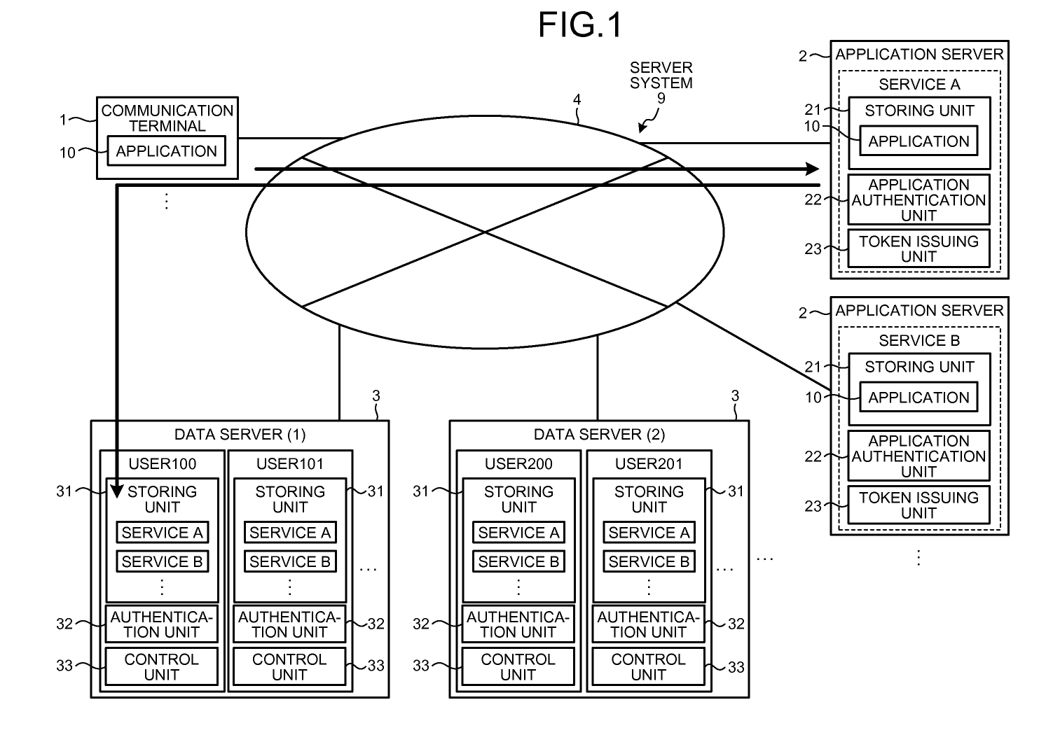

FIG. 1 is a block diagram illustrating the overall configuration of a server system according to a first embodiment. As illustrated in FIG. 1, a server system 9 includes the terminal device side that includes a communication terminal 1, the service side that includes multiple application servers 2, and the individual data store side that includes multiple data servers 3. The terminal device side is connected to the service side and the individual data store side via a network 4, i.e., the Internet. Specifically, by separating the service side from the individual data store side, the server system 9 allows the terminal device side to control its own data. More specifically, by allowing the terminal device side to use applications provided by multiple services, the server system 9 accesses the data server 3 specified by a user on the terminal device side and centrally manages personal data on users by using the data servers 3.

The communication terminal 1 is provided on the terminal device side. For example, an application 10 that is delivered by the application server 2 is stored in the communication terminal 1. The communication terminal 1 may also be, for example, a smart phone, a personal handy-phone system (PHS), or a personal digital assistants (PDA). Any communication terminal may also be used as long as it can communicate. The application 10 is a program that is used by the mobile terminal side to receive a service provided by the application server 2 on the service side. The communication terminal 1 acquires an application, which is associated with a service that a user desires to be provided, from one of the application servers 2 that provides the desired service and then stores the application in a random access memory (RAM) or hard disk drive (HDD).

The communication terminal 1 in which the application 10 is stored is provided on the terminal device side; however, the configuration is not limited thereto. The communication terminal 1 provided on the terminal side may also be of a different type. For example, a personal computer (PC) that stores therein the application 10 or a server that stores therein the application 10 may also be provided. Furthermore, a PC that does not store therein the application 10 may also access a server that stores therein the application 10.

The application servers 2 are provided on the service side. Each of the application servers 2 provides the communication terminal 1 with a service via the application 10 installed in the communication terminal 1. The application 10 may also be installed by being delivered from one of the application servers 2 or may also be installed by using another means. The application servers 2 may also be servers that provide a single service or may also be servers that provide multiple services. In this example, the application servers 2 are servers that provide a single service. Furthermore, each of the application servers 2 includes a storing unit 21, an application authentication unit 22, and a token issuing unit 23.

The data servers 3 are provided on the individual data store side. The data servers 3 are servers that include data storing areas (referred to as “data store”). The data servers 3 indicate, for example, providers that provide the data store. Furthermore, each of the data servers 3 includes, for each user, a storing unit 31, an authentication unit 32, and a control unit 33.

If the application 10 in the communication terminal 1 acquires an access request for data that includes the data access destination, the application 10 requests authentication for itself from the application server 2. For example, the application 10 acquires, a user, a user identification (ID), a user password, and information on the data server 3, which is the data access destination desired by the user. Then, the application 10 sends the information related to the application 10 and the information on the data server 3 to the application server 2. The information related to the application mentioned here is, for example, an application ID unique to an application (hereinafter, referred to as an application ID) and a password for an application (hereinafter, referred to as an application password). The information related to an application is embedded in a predetermined area in the application 10. The information on the data server 3 is, for example, a URL for the data server 3. A different application ID may also be used depending on the type of terminal.

Furthermore, by using an application authentication token that is issued when the application server 2 authenticates the legitimacy of the application 10, the application 10 in the communication terminal 1 accesses the data server 3 that is the data access destination desired by a user. For example, the application 10 sends a user ID, a user password, and an application authentication token to the data server 3 that is the data access destination specified by a user. The content of the application authentication token will be described later.

Furthermore, by using the data access token issued when the data server 3 authenticates the legitimacy of the application 10 in the communication terminal 1, the application 10 accesses the detailed access destination of data in the data server 3. The detailed access destination of data is then acquired from a user. The content of the data access token will be described later.

The storing unit 21 in the application server 2 corresponds to a nonvolatile semiconductor memory device, such as a flash memory, a ferroelectric random access memory (FRAM) (registered trademark), and the like, or a storage device, such as a hard disk (HDD). The storing unit 21 includes, for example, the application 10. This application 10 is delivered to the communication terminal 1.

On the basis of information that has been received from the communication terminal 1 and that is related to the application 10 in the terminal, the application authentication unit 22 in the application server 2 authenticates the application 10. For example, the application authentication unit 22 acquires, from the communication terminal 1, information related to the application 10 and information on the data access destination. Then, the application authentication unit 22 determines whether information related to the application 10, i.e., the application ID and the application password, is legitimate.

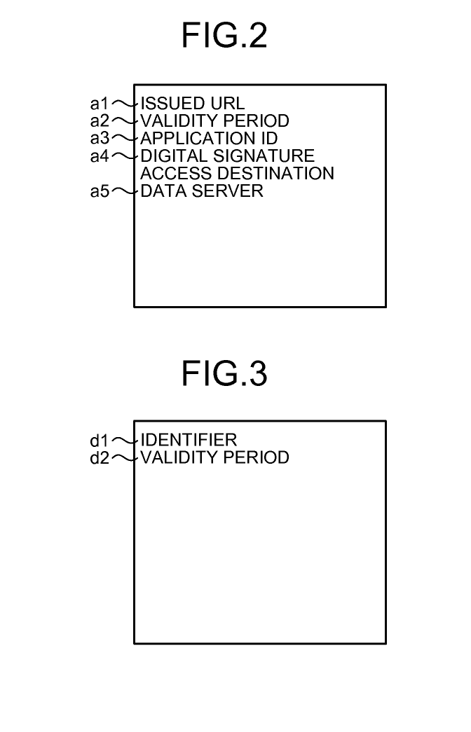

If the legitimacy of the application 10 is authenticated, the token issuing unit 23 in the application server 2 issues an application authentication token that includes information, which has been received from the communication terminal 1, on the data server 3, i.e., the data access destination. In the following, the content of the application authentication token will be described with reference to FIG. 2. FIG. 2 is a schematic diagram illustrating an example of the content of an application authentication token.

As illustrated in FIG. 2, the application authentication token stores therein, in an associated manner, an issued uniform resource locator (URL) a1, a validity period a2, an application ID a3, a digital signature a4, and an access destination data server a5. The issued URL a1 indicates a URL of the issue source that issues an application authentication token. In this example, the URL of a service that issues an application authentication token is set in the issued URL a1. The validity period a2 indicates the period for which an application authentication token to be issued is valid. For example, one hour is set therein.

The application ID a3 indicates an application ID of the application 10 in a terminal that uses an application authentication token. In this example, the application ID received from the communication terminal 1 is set in the application ID a3. If a different application ID a3 is used for each type of terminal, it is possible to set a function limit for each type of terminal. For example, the access function level can be changed for each type of terminal.

The digital signature a4 guarantees the legitimacy of an application authentication token and indicates that no alteration or counterfeit has been performed. The access destination data server a5 indicates the destination of the data server 3 that is accessed by the application 10 in order to access data in the data server 3. In this example, information, which has been received from the communication terminal 1, on the data server 3 that is the data access destination is set in the access destination data server a5.

A description will be given here by referring back to FIG. 1. If the legitimacy of the application 10 has been authenticated, the token issuing unit 23 sends, to the communication terminal 1, an authentication result indicating that legitimacy has been authenticated and an application authentication token. In contrast, if the legitimacy of the application 10 has not been authenticated, the token issuing unit 23 sends, to the communication terminal 1, an authentication result indicating that legitimacy has not been authenticated.

The storing unit 31 in the data server 3 corresponds to a nonvolatile semiconductor memory device, such as a flash memory or a ferroelectric random access memory (FRAM) (registered trademark) or a storage device, such as a hard disk. The storing unit 31 is divided into units of users and then managed. The users mentioned here correspond to the users of the communication terminal 1. The service mentioned here corresponds to a service provided by the application server 2. For example, if the communication terminal 1 used by a user 100 receives a service via the application 10 of a service A, the communication terminal 1 used by the user 100 can access a data area associated with the service A in the storage area that is allocated to the user 100 in the data server 3 that is specified by the user 100.

The authentication unit 32 in the data server 3 authenticates the legitimacy of an application authentication token on the basis of the application authentication token received from the communication terminal 1. For example, the authentication unit 32 determines whether the access destination data server a5 included in the application authentication token indicates its own data server 3 from among the data servers 3. Consequently, the authentication unit 32 can authenticate the legitimacy of the access destination data server a5 included in the application authentication token. Furthermore, on the basis of the application authentication token, the authentication unit 32 determines whether the issued URL a1 included in the application authentication token indicates the URL of a service. Consequently, the authentication unit 32 authenticates the legitimacy of the issue URL a1 included in the application authentication token. Furthermore, on the basis of the application authentication token, the authentication unit 32 determines whether the digital signature a4 is included in the application authentication token. Furthermore, on the basis of the application authentication token, the authentication unit 32 determines whether the current time is within the validity period a4 included in the application authentication token. Consequently, the authentication unit 32 can authenticate the legitimacy of the application authentication token itself.

Furthermore, the authentication unit 32 in the data server 3 authenticates the legitimacy of a user on the basis of the user ID and the user password received from the communication terminal 1. For example, the authentication unit 32 determines whether the user ID and the user password match the user managed by the authentication unit 32.

Furthermore, if the legitimacy of both the application authentication token and the user are authenticated, the authentication unit 32 creates a data access token. Then, the authentication unit 32 sends, to the communication terminal 1, both an authentication result indicating that the legitimacy is authenticated and the created data access token. Consequently, the application 10 in the communication terminal 1 can access, by using the created data access token, the access destination of the data that is associated with the service indicated by the issued URL a1. In the following, the content of the data access token will be described with reference to FIG. 3. FIG. 3 is a schematic diagram illustrating an example of the content of a data access token.

As illustrated in FIG. 3, an identifier d1 and a validity period d2 are set in a data access token in an associated manner. The identifier d1 is information that uniquely represents a data access token. For example, an identification number is used for the identifier d1; however, an identification name may also be used. Any identifier may also be used as long as the data access token can be identified. The validity period d2 indicates the period for which a data access token to be issued is valid. For example, one hour is set therein.

A description will be given here by referring back to FIG. 1. If the legitimacy of an application authentication token has not been authenticated, the authentication unit 32 sends, to the communication terminal 1, an authentication result indicating that the legitimacy has not been authenticated.

On the basis of the data access token received from the communication terminal 1, the control unit 33 controls the access of the application 10 in the communication terminal 1 to data. For example, on the basis of the data access token received from the communication terminal 1, the control unit 33 determines whether the current time is within the validity period d2 that is included in the data access token. Consequently, the control unit 33 can check the validity of the data access token. If it is determined that the current time is within the validity period d2, the control unit 33 permits access to data stored in the detailed access destination that is received from the communication terminal 1.

If the application ID a3 included in the application authentication token that is used by the authentication unit 32 varies in accordance with the type of terminal, the control unit 33 can set a different access restriction for each type of terminal. Specifically, in accordance with the application ID a3 included in the application authentication token, the control unit 33 controls access to data stored in the detailed access destination that is received from the communication terminal 1. For example, if the application ID a3 represents the ID of the communication terminal 1, the control unit 33 performs a control such that access to the data in the access destination permits only reading thereof. If the application ID a3 represents an ID of a server, the control unit 33 performs a control such that access to the data in the access destination permits writing of the data thereto.

Flow of the Process on the Terminal Device Side

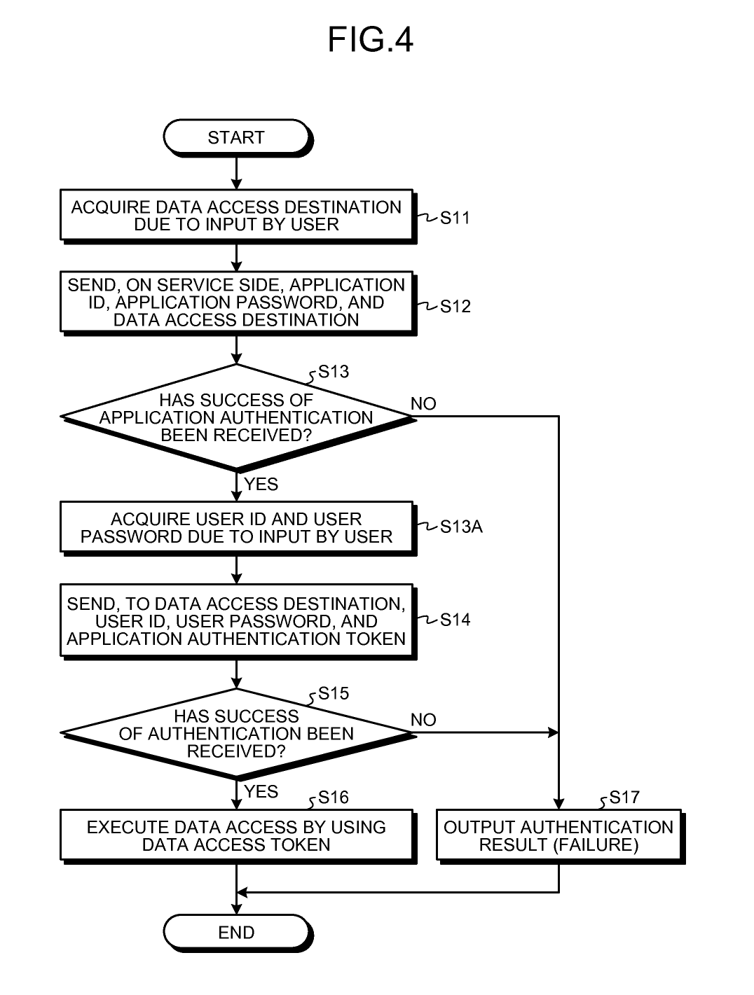

In the following, the flow of the process performed on the terminal device side will be described with reference to FIG. 4. FIG. 4 is a flowchart illustrating the flow of a process performed on the terminal device side according to the first embodiment. A description will be given with the assumption that the terminal on the terminal device side is the communication terminal 1.

First, the application 10 in the communication terminal 1 acquires the data access destination due to an input by a user (Step S11). The data access destination mentioned here is, for example, an URL of the data server 3 that the user desires to access.

Then, the application 10 sends, on the service side, an application ID, an application password, and the data access destination (Step S12). For example, the application ID and the application password are embedded in a predetermined area in the application 10. The application 10 extracts the application ID and the application password embedded in the predetermined area and then sends the extracted application ID and the application password to the service that is associated therewith.

Then, the application 10 determines whether an authentication result indicating that the authentication (application authentication) of the application 10 has been successful is received from the service side (Step S13). If it is determined that the authentication result indicating that the application authentication has been successful is received (Yes at Step S13), the application 10 acquires a user ID and a user password that are input by a user (Step S13A).

Then, the application 10 sends, to the data access destination, the user ID, the user password, and the application authentication token that was received from the service side (Step S14). Specifically, the application 10 sends the user ID, the user password, and the application authentication token to the data access destination acquired from the user, i.e., the URL of the data server 3 that the user desires to access.

In contrast, if it is determined that an authentication result indicating that the application authentication has been successful is not received (No at Step S13), the application 10 outputs the authentication result indicating that application authentication has failed to, for example, a monitor (Step S17).

Subsequently, the application 10 determines whether the authentication result indicating that the authentication has been successful is received from the data server 3 (Step S15). If it is determined that the authentication result indicating that the authentication has been successful is received (Yes at Step S15), the application 10 executes data access by using the data access token received from the data server 3 (Step S16). For example, the application 10 accesses, by using the data access token, the data in the detailed access destination acquired from the user. Specifically, the application 10 can access a data area that is allocated to the user and that is associated with a service in the storage area in the data server 3 that is specified by the user.

In contrast, if it is determined that the authentication result indicating the authentication has been successful is not received (No at Step S15), the application 10 outputs the authentication result indicating that the authentication has failed to, for example, the monitor (Step S17).

Flow of the Application Authentication Process Performed by the Application Server

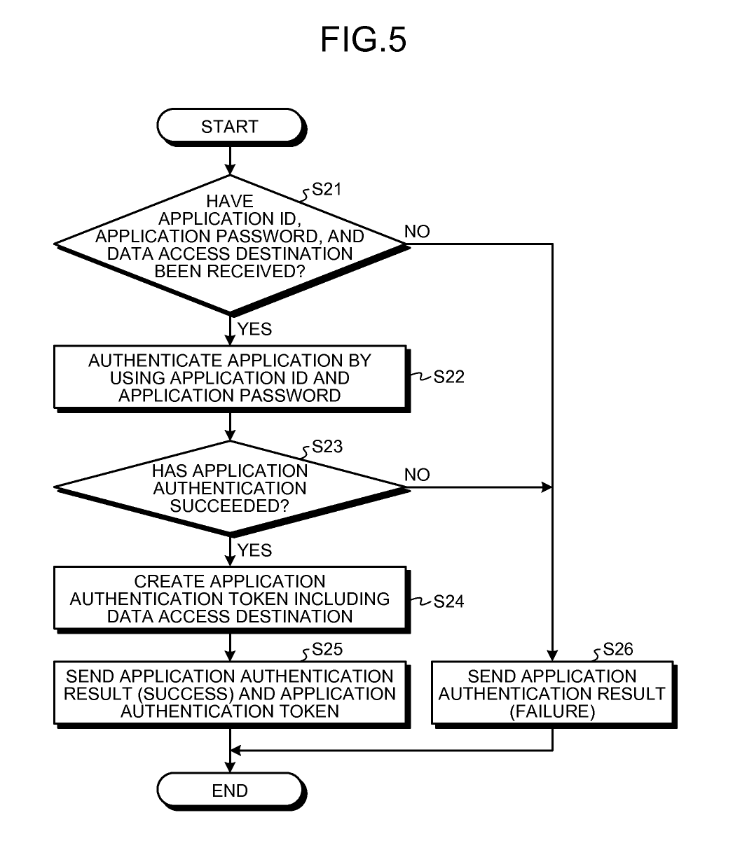

In the following, the flow of an application authentication process performed by the application server 2 will be described with reference to FIG. 5. FIG. 5 is a flowchart illustrating an application authentication process performed by an application server according to the first embodiment.

The application authentication unit 22 in the application server 2 determines whether an application ID, an application password, and a data access destination have been received from the terminal device side (Step S21). If it is determined that the application ID, the application password, and the data access destination have not been received (No at Step S21), the application authentication unit 22 moves to Step S26 in order to send, to the communication terminal 1 that is the transmission source, an authentication result indicating that the application authentication has failed.

In contrast, if it is determined that an application ID, an application password, and a data access destination have been received (Yes at Step S21), the application authentication unit 22 authenticates the application 10 by using the application ID and the application password (Step S22).

Then, the application authentication unit 22 determines whether the authentication (application authentication) of the application 10 has been successful (Step S23). If it is determined that application authentication has been successful (Yes at Step S23), the token issuing unit 23 creates an application authentication token that includes the data access destination (Step S24). Then, the token issuing unit 23 sends, to the communication terminal 1 that is the transmission source, both an authentication result indicating that the application authentication has been successful and the created application authentication token (Step S25).

In contrast, if it is determined that application authentication has not been successful (No at Step S23), the token issuing unit 23 sends, to the communication terminal 1 that is the transmission source, an authentication result indicating that the application authentication has failed (Step S26).

Flow of the Authentication Process Performed by the Data Server

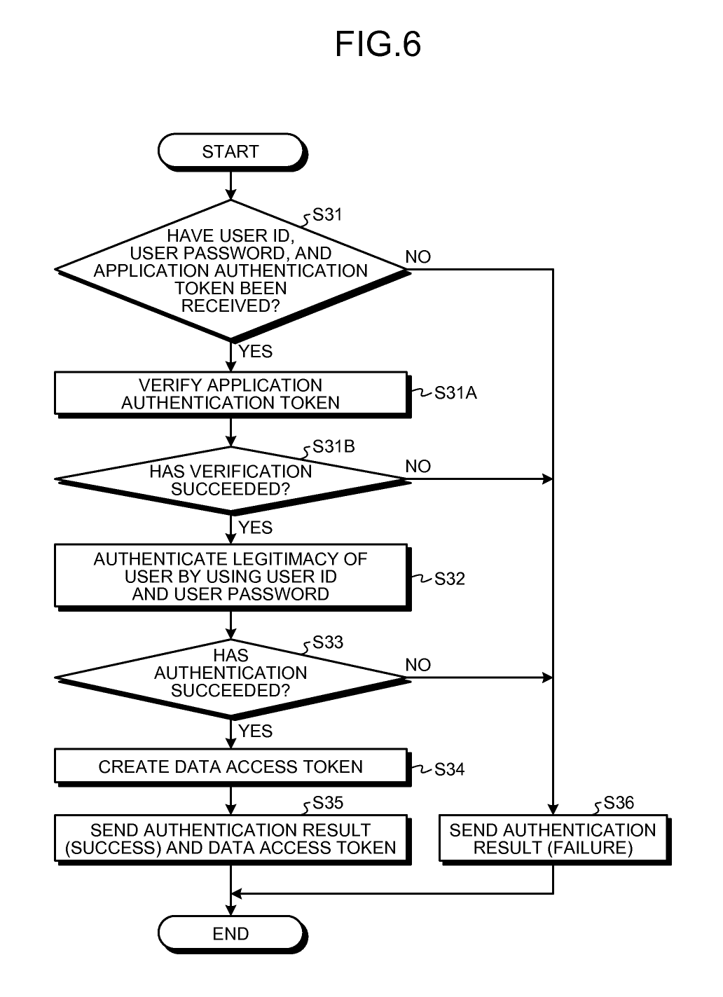

In the following, the flow of the authentication process performed by the data server 3 will be described with reference to FIG. 6. FIG. 6 is a flowchart illustrating the authentication process performed by the data server according to the first embodiment.

The authentication unit 32 in the data server 3 determines whether a user ID, a user password, and an application authentication token have been received from the communication terminal 1 (Step S31). If it is determined that a user ID, a user password, and an application authentication token have not been received (No at Step S31), the authentication unit 32 moves to Step S36 in order to send, to the communication terminal 1 that is the transmission source, an authentication result indicating that authentication has failed.

In contrast, if it is determined that a user ID, a user password, and an application authentication token have been received (Yes at Step S31), the authentication unit 32 verifies the application authentication token (Step S31A). Then, the authentication unit 32 determines whether verification of the application authentication token has been successful (Step S31B). If it is determined that verification of the application authentication token has not been successful (No at Step S31B), the authentication unit 32 moves to Step S36 in order to send, to the communication terminal 1 that is the transmission source, an authentication result indicating that authentication has failed.

In contrast, if it is determined that verification of the application authentication token has been successful (Yes at Step S31B), the authentication unit 32 authenticates the legitimacy of a user by using the user ID and the user password (Step S32).

Then, the authentication unit 32 determines whether the authentication has been successful (Step S33). If it is determined that the authentication has been successful (Yes at Step S33), the authentication unit 32 creates a data access token (Step S34). Then, the authentication unit 32 sends, to the communication terminal 1 that is the transmission source, both an authentication result indicating that an authentication has been successful and the created data access token (Step S35).

In contrast, if it is determined that the authentication has not been successful (No at Step S33), the authentication unit 32 sends, to the communication terminal 1 that is the transmission source, an authentication result indicating that the authentication has failed (Step S36).

Then, if the control unit 33 receives the data access token and the detailed access destination of the data from the communication terminal 1, the control unit 33 controls, on the basis of the data access token, access to data in the detailed access destination. For example, the control unit 33 determines whether the current time is within the validity period that is included in the data access token. If it is determined that the current time is within the validity period, the control unit 33 permits access to the data in the detailed access destination. In contrast, if the current time is not within the validity period, the control unit 33 does not permit access to the data stored in the detailed access destination.

The description thus far has been given with the assumption that the token issuing unit 23 in the application server 2 includes the validity period a2 of an application authentication token in the application authentication token. Furthermore, a description thus far has been given with the assumption that the authentication unit 32 in the data server 3 includes the validity period d2 of the data access token in the data access token. For these validity periods, a different validity period may also be used for each type of terminal on the terminal device side. For example, when compared with a PC or a movable communication terminal, the operation of the application 10 in a server is less likely to be falsely verified. Accordingly, the validity period of the server may be set longer than that related to a PC or a movable communication terminal. If the application ID a3 differs for each type of terminal, it is possible to identify which terminal it is, i.e., a server, a PC, or a movable communication terminal. Consequently, the server system 9 can improve the security of the entire system.

### Advantage of the First Embodiment

According to the embodiment described above, the application server 2 authenticates the application 10 on the basis of the application ID and the application password, of the application 10 included in the terminal, that are received from the communication terminal 1. Then, if the legitimacy of the application 10 has been authenticated, the application server 2 issues an application authentication token that includes server information on the data server 3 that stores therein data accessed by the application 10. Then, on the basis of the application authentication token received from the communication terminal 1, the data server 3 determines whether the server information included in the application authentication token indicates its own data server 3 from among the data servers 3. If the server information indicates its own data server 3, the data server 3 permits the application 10 in the communication terminal 1 to access the data. With this configuration, the communication terminal 1 accesses the data in the data server 3 by using an application authentication token that is issued by being authenticated by the application server 2. Accordingly, because the application ID and the application password of the application 10 are not sent to the data server 3 as a notification, the application ID and the application password of the application 10 do not leak into the malicious data server 3. Consequently, the server system 9 that includes the application server 2 and the data server 3 can prevent an illegitimate application from using the application ID and the application password of the application 10 to pretend to be the application 10 in the malicious data server 3.

Furthermore, according to the embodiment described above, the application server 2 issues an application authentication token that includes the access level of data specified by the application ID. Then, the data server 3 permits the application 10 in the communication terminal 1 to access the data in accordance with the access level included in the application authentication token. With this configuration, by including the access level of the data specified by the application ID in the application authentication token, the application server 2 can indirectly manage access to data by the data server 3. Specifically, by using an application authentication token that includes the access level of data, the application server 2 permits the data server 3 to access data in accordance with the access level of data.

Furthermore, according to the embodiment described above, the application server 2 issues an application authentication token that includes server information indicating the data server 3 specified by a user of the communication terminal 1. With this configuration, because the application server 2 allows the communication terminal 1 to access the data server 3 by using an application authentication token, it is possible to access the data server 3 that is specified by a user and that is indicated by the information included in the application authentication token. Consequently, the user can manage his/her own data by himself/herself by using the data server 3 specified by the user.

### [b] Second Embodiment

In the server system 9 according to the first embodiment, the description thus far has been given of a case in which the data server 3 authenticates the legitimacy of a user. Specifically, the application 10 installed in the communication terminal 1 sends, to the data server 3, an application authentication token, which can be obtained when the application server 2 authenticates the application 10, a user ID and a user password. In addition to the verification of an application authentication token, if authentication of the legitimacy of a user is successful, the data server 3 can access the data server 3 that is the data access destination specified by a user. However, in the server system 9, the configuration is not limited thereto. For example, there may also be a case in which the data server 3 does not authenticate the legitimacy of a user. Specifically, instead of authenticating the legitimacy of the user, the data server 3 can access the data server 3 that is the data access destination specified by a user as long as the verification of the application authentication token has been successful.

Accordingly, in a second embodiment, a description will be given of the server system 9 that can access the data server 3 that is the data access destination specified by a user as long as the verification of an application authentication token has been successful even when the data server 3 does not authenticate the legitimacy of a user.

Server System According to the Second Embodiment

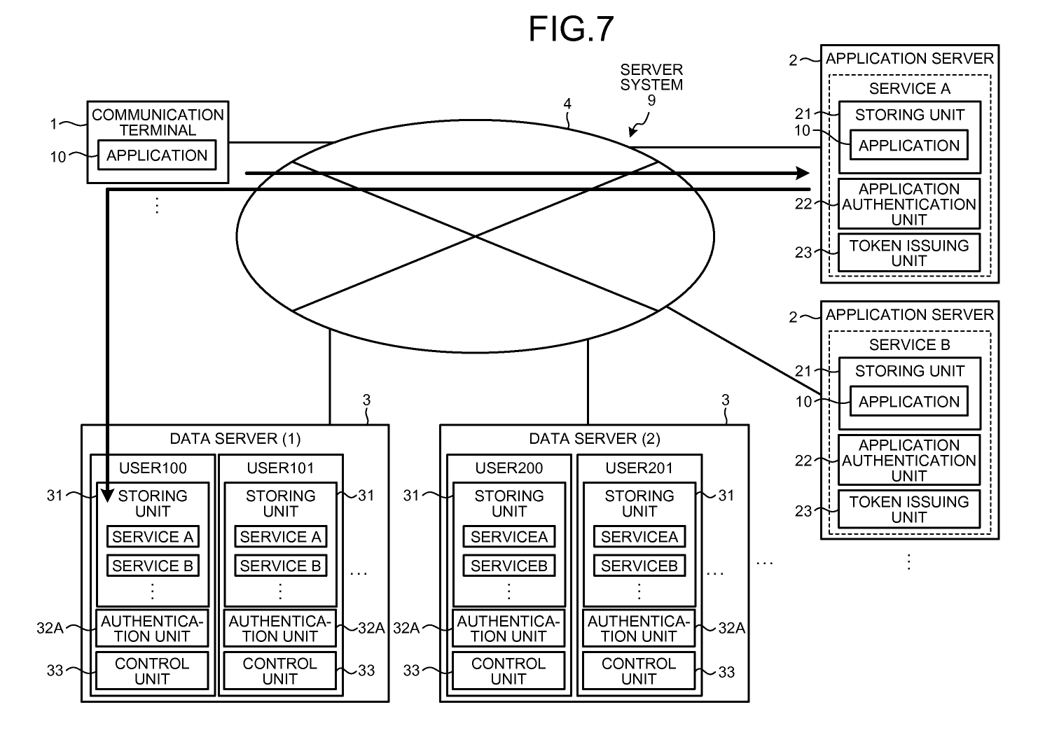

FIG. 7 is a functional block diagram illustrating the overall configuration of a server system according to a second embodiment. The components having the same configuration as those in the server system 9 illustrated in FIG. 1 are assigned the same reference numerals; therefore, descriptions of the configuration and the operation thereof will be omitted. The second embodiment differs from the first embodiment in that an authentication unit 32A is used in the data server 3 instead of the authentication unit 32.

The application 10 in the communication terminal 1 acquires, from a user, a user ID, a user password and information on the data server 3 desired by the user as the data access destination. Then, the application 10 sends the information related to the application 10 and the information on the data server 3 to the application server 2. Furthermore, the application 10 in the communication terminal 1 sends, to the data server 3 that is the data access destination specified by the user, an application authentication token that is issued when the application server 2 authenticates the legitimacy of the application 10.

On the basis of an application authentication token received from the communication terminal 1, the authentication unit 32A in the data server 3 authenticates the legitimacy of the application authentication token. Furthermore, the authentication unit 32A creates a data access token if the legitimacy of the application authentication token has been authenticated. Then, the authentication unit 32A sends, to the communication terminal 1, both an authentication result indicating that the legitimacy has been authenticated and the created data access token. Consequently, by using the created data access token, the application 10 in the communication terminal 1 can access the access destination of the data that is associated with the service indicated by the issued URL a1. Specifically, the application 10 can access the data in a simple manner without using a user authentication as long as the application authentication token in which that the application 10 has been authenticated can be obtained. An example of data in the access destination includes data that can be read but not written. A specific example of data in the access destination includes information on a manual that is desired to be disclosed only to users who use the specific application 10 or information on an internal operation limited to be read.

Flow of the Process on the Terminal Device Side

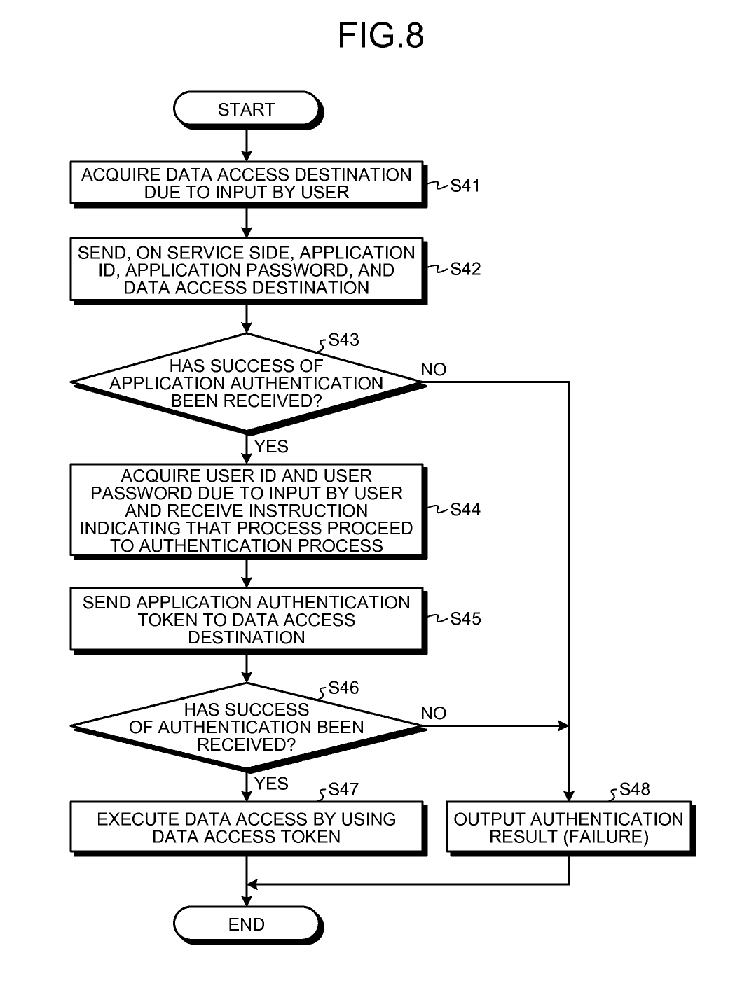

In the following, the flow of the process performed on the terminal device side will be described with reference to FIG. 8. FIG. 8 is a flowchart illustrating the flow of a process performed on the terminal device side according to the second embodiment. A description will be given with the assumption that the terminal on the terminal device side is the communication terminal 1.

First, the application 10 in the communication terminal 1 acquires the data access destination that is input by a user (Step S41). Here, the data access destination is, for example, an URL of the data server 3 the user desires to access.

Then, the application 10 sends an application ID, an application password, and a data access destination to the service side (Step S42). For example, the application ID and the application password are embedded in a predetermined area in the application 10. The application 10 extracts the application ID and the application password embedded in the predetermined area and then sends the extracted application ID and the application password to a service associated therewith.

Subsequently, the application 10 determines whether an authentication result indicating that the authentication (application authentication) of the application 10 has been successful is received from the service side (Step S43). If it is determined that the authentication result indicating that the application authentication has been successful is received (Yes at Step S43), the application 10 acquires a user ID and a user password that are input by a user and receives an instruction indicating that the process proceeds to the authentication process (Step S44).

Then, the application 10 sends, to the data access destination, the application authentication token received from the service side (Step S45). Specifically, the application 10 sends the application authentication token to the data access destination received from a user, i.e., an URL of the data server 3 that the user desires to access.

In contrast, if it is determined that an authentication result indicating that the application authentication has been successful is not received (No at Step S43), the application 10 outputs the authentication result indicating that the application authentication has failed to, for example, the monitor (Step S48).

Subsequently, the application 10 determines whether the authentication result indicating that the authentication has been successful is received from the data server 3 (Step S46). If it is determined that the authentication result indicating that the authentication has been successful is received (Yes at Step S46), the application 10 executes data access by using the data access token received from the data server 3 (Step S47). For example, the application 10 accesses, by using the data access token, the detailed access destination of the data acquired from a user. Specifically, even if the authentication of a user is not performed, the application 10 can access a data area that is allocated to the user and that is associated with a service in the storage area in the data server 3 that is specified by the user.

In contrast, if it is determined that an authentication result indicating that the authentication has been successful is not received (No at Step S46), the application 10 outputs the authentication result indicating that the authentication has failed to, for example, the monitor (Step S48).

Flow of the Application Authentication Process Performed by the Application Server

The flow of the application authentication process performed by the application server 2 has already been described with reference to FIG. 5; therefore, a description thereof will be omitted.

Flow of the Authentication Process Performed by the Data Server

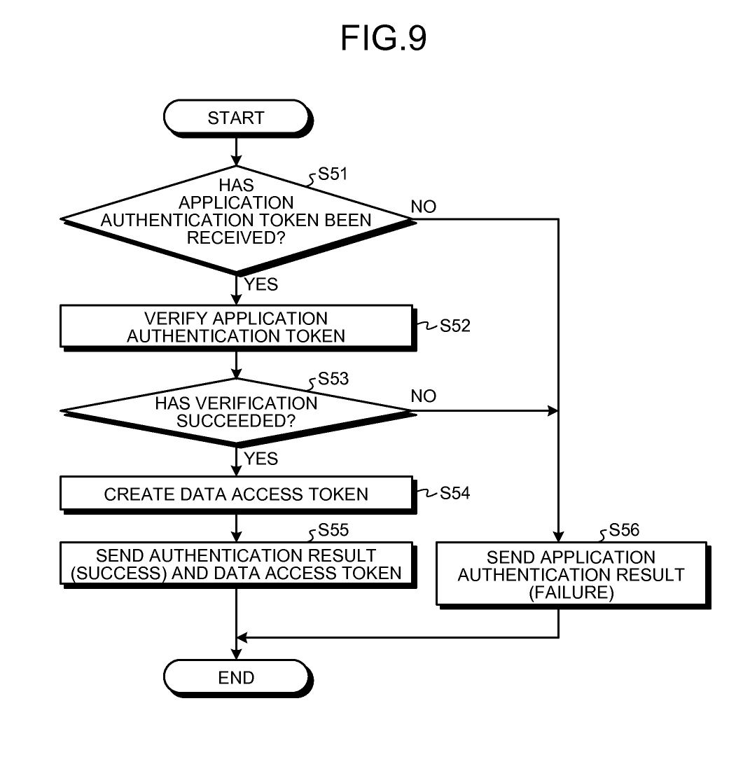

In the following, the flow of the authentication process performed by the data server 3 will be described with reference to FIG. 9. FIG. 9 is a flowchart illustrating the flow of the authentication process performed by the data server according to the second embodiment.

The authentication unit 32A in the data server 3 determines whether an application authentication token has been received from the communication terminal 1 (Step S51). If it is determined that the application authentication token has not been received (No at Step S51), the authentication unit 32A moves to Step S56 in order to send an authentication result indicating that authentication has failed to the communication terminal 1 that is the transmission source.

In contrast, if it is determined that the application authentication token has been received (Yes at Step S51), the authentication unit 32A verifies the application authentication token (Step S52). Then, the authentication unit 32A determines whether verification of the application authentication token has been successful (Step S53). If it is determined that the verification of the application authentication token has not been successful (No at Step S53), the authentication unit 32A moves to Step S56 in order to send, to the communication terminal 1 that is the transmission source, an authentication result indicating that authentication has failed.

In contrast, if it is determined that verification of the application authentication token has been successful (Yes at Step S53), the authentication unit 32A creates a data access token (Step S54). Then, the authentication unit 32A sends, to the communication terminal 1 that is the transmission source, both an authentication result indicating that the authentication has been successful and the created data access token (Step S55).

In contrast, if it is determined that the verification of the application authentication token has not been successful (No at Step S53), the authentication unit 32A sends, to the communication terminal 1 that is the transmission source, an authentication result indicating that the authentication has failed (Step S56).

Then, if the control unit 33 receives the data access token and the detailed access destination of the data from the communication terminal 1, the control unit 33 controls, on the basis of the data access token, access to the data in the detailed access destination. For example, the control unit 33 determines whether the current time is within the validity period included in the data access token. If it is determined that the current time is within the validity period, the control unit 33 permits access to the data in the detailed access destination. In contrast, if it is determined that the current time is not within the validity period, the control unit 33 does not permit access to the data in the detailed access destination.

### Advantage of the Second Embodiment

According to the second embodiment, the application server 2 authenticates the application 10 on the basis of the application ID and the application password, of the application 10 included in the terminal, that are received from the communication terminal 1. Then, if the legitimacy of the application 10 has been authenticated, the application server 2 issues an application authentication token that includes server information on the data server 3 that stores therein data accessed by the application 10. If the authentication unit 32A in the data server 3 receives only an application authentication token from the communication terminal 1, the authentication unit 32A determines, on the basis of the application authentication token, whether the server information included in the application authentication token indicates its own data server 3 from among the data servers 3. If the server information indicates its own data server 3, the data server 3 permits the application 10 in the communication terminal 1 to access the data. With this configuration, the application 10 in the communication terminal 1 can access the data in a simple manner without using a user authentication as long as the application authentication token indicating that the application 10 has been authenticated is provided.

### [c] Third Embodiment

In the server system 9 according to the second embodiment, the description thus far has been given of a case in which the application 10 installed in the communication terminal 1 accesses the data access destination that is specified by a user. Specifically, the application 10 installed in the communication terminal 1 sends, to the data server 3, only the application authentication token that includes the information on the data server 3 that is the data access destination specified by the user. If the data server 3 verifies the application authentication token and if the verification is successful, the application 10 accesses the data server 3 that is the data access destination specified by the user. However, the embodiment is not limited thereto in the server system 9. For example, the application 10 installed in the communication terminal 1 may also access a data access destination determined by a service, such as a destination that is shared by users and that is not previously known by the users.

Accordingly, in a third embodiment, a description will be given of the server system 9 in which the application 10 installed in the communication terminal 1 can access the data access destination determined by a service.

Server System According to the Third Embodiment

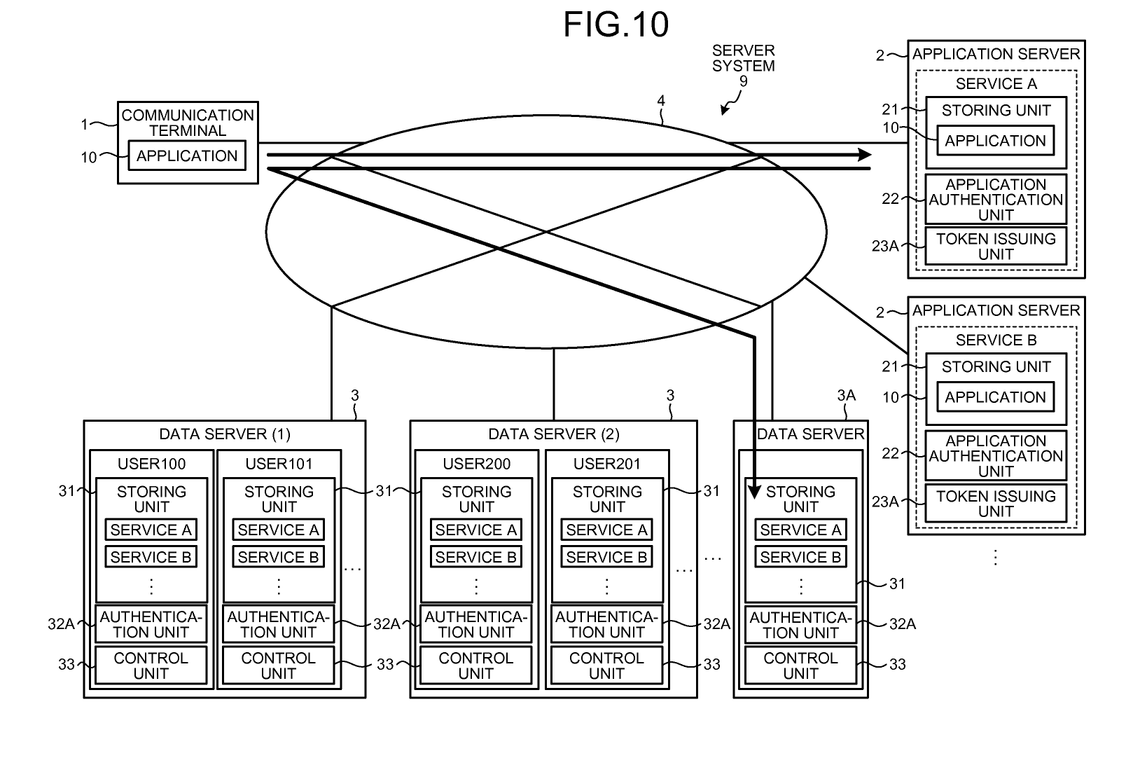

FIG. 10 is a functional block diagram illustrating the overall configuration of a server system according to the third embodiment. The components having the same configuration as those in the server system 9 illustrated in FIG. 1 are assigned the same reference numerals; therefore, descriptions of the same configuration and operation thereof will be omitted. The configuration in the third embodiment differs from the configuration in the second embodiment in that the server system 9 includes a token issuing unit 23A in the application server 2 and includes, on the individual data store side, a data server 3A that includes the storing unit 31 that is not used for each user but is managed by each service.

When the application 10 in the communication terminal 1 acquires an access request for data that includes a keyword for the data access destination, the application 10 requests its own authentication from the application server 2. For example, the application 10 acquires a keyword for the data access destination that is desired by a user. Then, the application 10 sends, to the application server 2, information on the application 10 and the keyword for the data access destination. The information on the application mentioned here means an application ID and an application password. The information on the application is embedded in a predetermined area in the application 10.

The keyword for the data access destination mentioned here indicates information with which a service can determine the data access destination (information on the data server 3A). Examples of a keyword for the data access destination include the “XXX relation” by which the data access destination of a user support forum related to XXX can be determined and the “YYY relation” by which the data access destination of frequently asked questions (FAQ) related to YYY can be determined.

Furthermore, the application 10 in the communication terminal 1 acquires, from the application server 2, data access destination information and an application authentication token that is issued when the legitimacy of the application server 2 is authenticated. The data access destination information mentioned here means information on the data server 3A that is the data access destination and that is determined by the application server 2 from the keyword for the data access destination. Then, by using the application authentication token, the application 10 accesses the data server 3A that is the data access destination and that is set in the data access destination information. For example, the application 10 sends the application authentication token to the data server 3A that is the data access destination and that is set in the data access destination information acquired from the application server 2.

If the legitimacy of the application 10 has been authenticated, the token issuing unit 23A in the application server 2 issues an application authentication token that includes the data access destination (information on the data server 3A) obtained from the determination by using the keyword for the data access destination. For example, from the keyword for the data access destination received from the communication terminal 1, the token issuing unit 23A determines a predetermined data access destination that is managed by the service provided by the data access destination. Then, the token issuing unit 23A issues an application authentication token that includes the predetermined data access destination obtained from the determination. The predetermined data access destination is set in the access destination data server a5 in the application authentication token. Then, the token issuing unit 23A creates a data access destination information that includes the predetermined access destination in order to send the predetermined data access destination as a notification.

Furthermore, if the legitimacy of the application 10 has been authenticated, the token issuing unit 23A sends, to the communication terminal 1, an authentication result indicating that the legitimacy has been authenticated, the application authentication token, and the data access destination information. Consequently, because the token issuing unit 23A can send back the data access destination associated with the keyword for the data access destination together with the token to the application 10, it is possible for the application 10 to access the data access destination without additionally changing the application 10.

On the basis of the application authentication token received from the communication terminal 1, the authentication unit 32A in the data server 3A authenticates the legitimacy of the application authentication token. Furthermore, if the legitimacy of the application authentication token is authenticated, the authentication unit 32A creates a data access token. Then, the authentication unit 32A sends, to the communication terminal 1, both an authentication result indicating that the legitimacy has been authenticated and the created data access token. Consequently, the application 10 in the communication terminal 1 can access, by using the created data access token, the access destination of the data that is associated with the service indicated by the issued URL a1. Furthermore, if the legitimacy of the application authentication token has not been authenticated, the authentication unit 32A sends, to the communication terminal 1, an authentication result indicating that the legitimacy has not been authenticated.

[Flow of the Process on the Terminal Device Side]

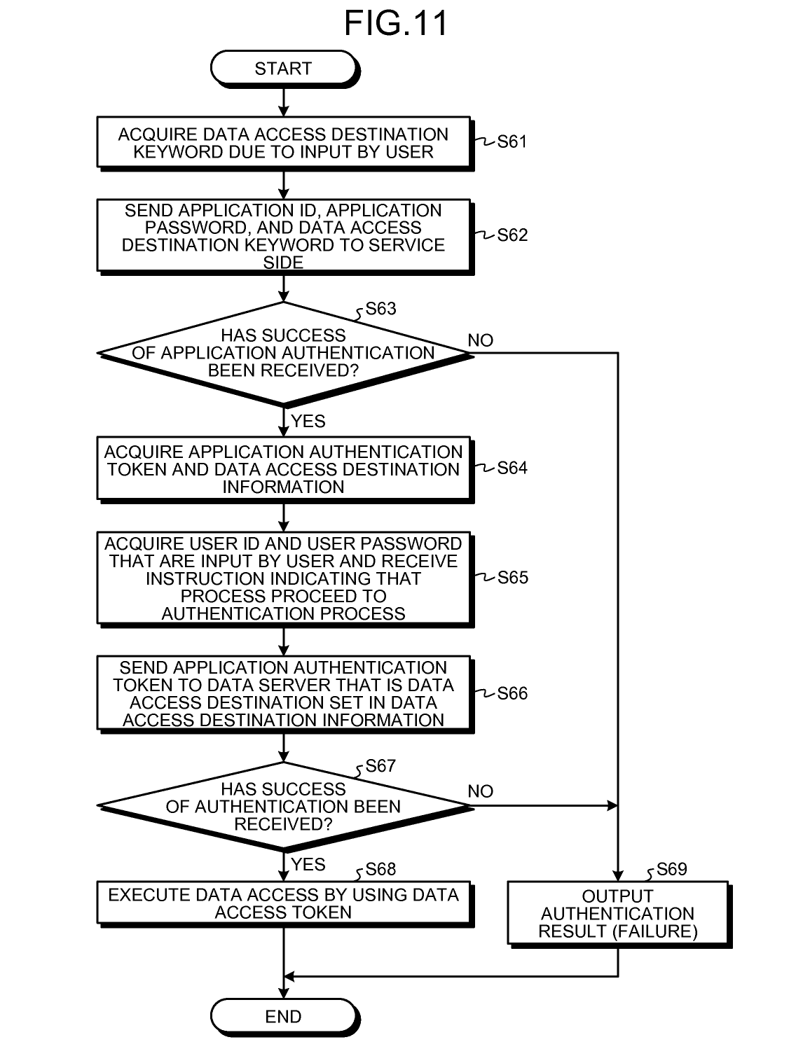

In the following, the flow of the process performed by the terminal device side will be described with reference to FIG. 11. FIG. 11 is a flowchart illustrating the flow of a process performed on the terminal device side according to the third embodiment. A description will be given with the assumption that the terminal on the terminal device side is the communication terminal 1.

First, the application 10 in the communication terminal 1 acquires a data access destination keyword that is input by a user (Step S61). The data access destination keyword mentioned here means information by which the data server 3A that is the data access destination of a service can be determined. Then, the application 10 sends the application ID, the application password, and the data access destination keyword to the service side (Step S62).

Subsequently, the application 10 determines whether an authentication result indicating that the authentication (application authentication) of the application 10 has been successful is received from the service side (Step S63). If it is determined that the authentication result indicating that the application authentication has been successful is received (Yes at Step S63), the application 10 acquires the application authentication token and the data access destination information received from the service side (Step S64). Then, the application 10 acquires the user ID and the user password that are input by the user and receives an instruction indicating that the process proceeds to the authentication process (Step S65).

Then, the application 10 sends the application authentication token to the data server 3A that is the data access destination and that is set in the data access destination information (Step S66). Specifically, the application 10 sends the application authentication token to the data access destination that is determined by a service on the basis of the data access destination keyword.

In contrast, if it is determined that an authentication result indicating that the application authentication has been successful is not received (No at Step S63), the application 10 outputs the authentication result indicating that the application authentication has failed to, for example, the monitor (Step S69).

Then, the application 10 determines whether an authentication result indicating that the authentication has been successful is received from the data server 3A (Step S67). If it is determined that the authentication result indicating that the authentication has been successful is received (Yes at Step S67), the application 10 executes the data access by using the data access token received from the data server 3A (Step S68). For example, the application 10 accesses the detailed access destination of the data that is acquired from a user by using the data access token. Specifically, the application 10 can access the data area that is associated with a service and that is in the storage area in the data server 3A specified by the service.

In contrast, if it is determined that the authentication result indicating that the authentication has been successful is not received (No at Step S67), the application 10 outputs the authentication result indicating that the authentication has failed to, for example, the monitor (Step S69).

Flow of the Application Authentication Process Performed by the Application Server

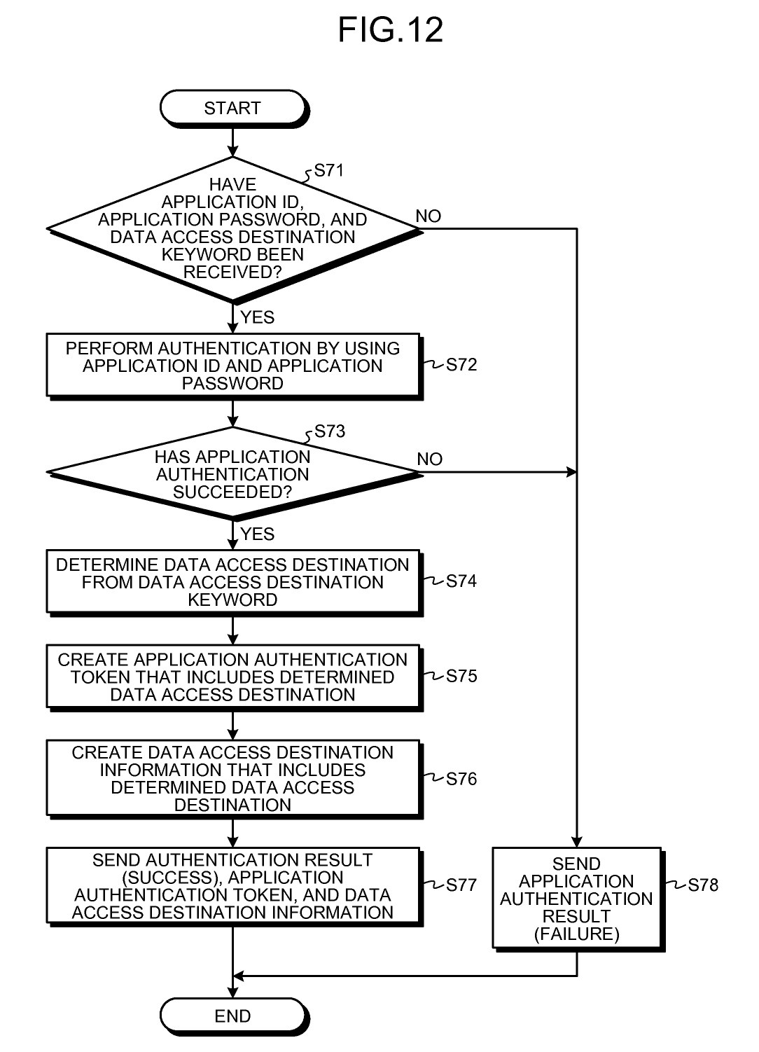

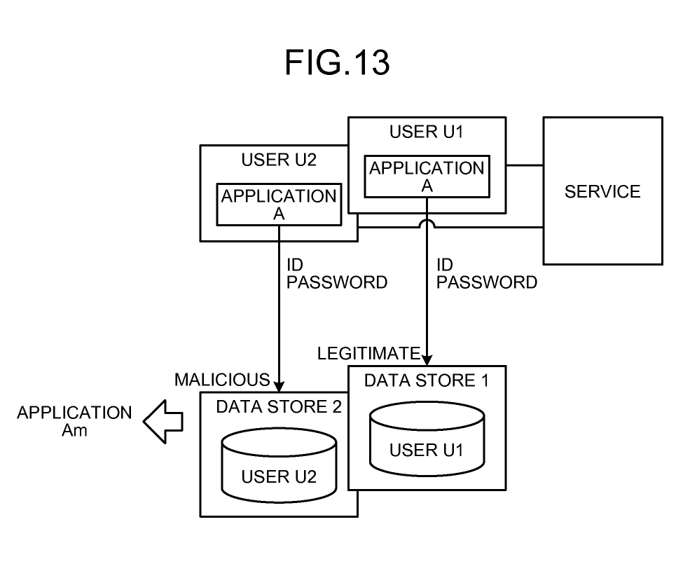

In the following, the flow of the application authentication process performed by the application server 2 will be described with reference to FIG. 12. FIG. 12 is a flowchart illustrating the flow of the application authentication process performed by the application server according to the third embodiment.

The application authentication unit 22 in the application server 2 determines whether an application ID, an application password, and a data access destination keyword have been received from the terminal device side (Step S71). If it is determined that the application ID, the application password, and the data access destination keyword have not been received (No at Step S71), the application authentication unit 22 moves to Step S78 in order to send, to the communication terminal 1 in the transmission source, an authentication result indicating that the application authentication has failed.

In contrast, if it is determined that an application ID, an application password, and a data access destination keyword have been received (Yes at Step S71), the application authentication unit 22 authenticates the application 10 by using the application ID and the application password (Step S72).

Then, the application authentication unit 22 determines whether the authentication (application authentication) of the application 10 has been successful (Step S73). If it is determined that the application authentication has been successful (Yes at Step S73), the token issuing unit 23A determines the data access destination from the data access destination keyword (Step S74). For example, the token issuing unit 23A determines a predetermined data access destination managed by the service provided by the data access destination from the keyword for the data access destination.

Then, the token issuing unit 23A creates an application authentication token that includes the determined data access destination (Step S75). Then, the token issuing unit 23A creates data access destination information that includes the determined data access destination in order to send, as a notification, the determined data access destination to the communication terminal 1 that is the transmission source (Step S76). Then, the token issuing unit 23A sends, to the communication terminal 1 that is the transmission source, the authentication result indicating that the application authentication has been successful, the created application authentication token, and the created data access destination information (Step S77).

In contrast, if it is determined that the application authentication has not been successful (No Step S73), the token issuing unit 23A sends, to the communication terminal 1 that is the transmission source, an authentication result indicating that the application authentication has failed (Step S78).

Flow of the Authentication Process Performed by the Data Server

The flow of the authentication process performed by the data server 3A has been described with reference to FIG. 9; therefore, a description thereof will be omitted.

As described above, the token issuing unit 23A sends an application authentication token and data access destination information to the communication terminal 1. However, instead of sending the data access destination information, by referring to the access destination data server a5 specified by the application authentication token, the token issuing unit 23A may not need to send the data access destination information to the communication terminal 1. In such a case, the application 10 in the communication terminal 1 acquires the application authentication token from the application server 2 and refers to the access destination data server a5 that is included in the application authentication token. Then, the application 10 sends the application authentication token to the data server 3A indicated by the access destination data server a5. Consequently, because the token issuing unit 23A does not need to send the data access destination information to the communication terminal 1, it is possible to reduce the load of communication between the communication terminal 1 and the application server 2.

Furthermore, as described above, a keyword for the data access destination indicates the information with which a service can determine the data access destination (information on the data server 3A). However, a keyword for the data access destination is not limited thereto. For example, information (for example, an URL) managed by a service as a data access destination (information on the data server 3A) may also be used. In such a case, if the legitimacy of the application 10 is authenticated, the token issuing unit 23A in the application server 2 determines whether a service manages a keyword for the data access destination. If it is determined that the service manages the keyword, the token issuing unit 23A issues an application authentication token in which the keyword for the data access destination is set in the access destination data server a5 without processing anything. In contrast, if it is determined that the service does not manage the keyword, the token issuing unit 23A determines a predetermined data access destination managed by the service and then issues an application authentication token in which the predetermined data access destination obtained from the determination is set in the access destination data server a5. If the legitimacy of the application 10 has been authenticated, the token issuing unit 23A sends both an authentication result indicating that the legitimacy has been authenticated and the application authentication token to the communication terminal 1. Consequently, even if the service is information itself that manages the data access destination, by allowing a user to specify the information, the token issuing unit 23A allows the user to perform a versatile data access. Furthermore, because the token issuing unit 23A does not need to send data access destination information to the communication terminal 1, it is possible to reduce the load of communication between the communication terminal 1 and the application server 2.

Furthermore, the token issuing unit 23A issues an application authentication token that includes the data access destination (information on the data server 3A) obtained from the determination of a keyword for the data access destination. However, the function of the token issuing unit 23A is not limited thereto. For example, the token issuing unit 23A may also issue an application authentication token that includes the data access destination (information on the data server 3A) obtained from the determination of not only a keyword for the data access destination but also an application ID. Consequently, because the token issuing unit 23A can determine the data access destination in accordance with the application ID in addition to the keyword for the data access destination, the number of options of data access destinations to be determined increases. For example, if the token issuing unit 23A can distinguish versions in accordance with an application ID, it is possible to change data access destinations depending on different versions.

### Advantage of the Third Embodiment

According to the third embodiment described above, on the basis of an application ID and an application password, of the application 10 included in the terminal, that are received from the communication terminal 1, the application server 2 authenticates the application 10. Then, the token issuing unit 23A in the application server 2 issues, from a keyword for the data access destination that is specified by a user of the communication terminal 1, an application authentication token that includes information on the data server 3A that is the data access destination determined by its own server. If the data server 3A receives only the application authentication token from the communication terminal 1, the data server 3A determines, on the basis of the application authentication token, whether the server information included in the application authentication token indicates the data server 3A that is included in its own server. If it is determined that the server information indicates its own data server 3A, the data server 3A permits the application 10 in the communication terminal 1 to access the data. With this configuration, the application server 2 sends back, to the application 10 in the communication terminal 1, the data access destination that is associated with the keyword for the data access destination specified by a user such that the data access destination is included in the application authentication token. Consequently, the application server 2 can allow the communication terminal 1 to access the data access destination determined by the application server 2 itself without additionally change the application 10. Furthermore, even if a user of the application 10 does not previously know the information on the data access destination, the users who share the application 10 can access the data access destination that is determined by the application server 2 that is shared by the users. Specifically, the application 10 in the communication terminal 1 can access the data access destination shared by users without using a user authentication as long as an application authentication token in which the application 10 is authenticated is provided.

The application server 2 can be implemented by installing the functions performed by the storing unit 21, the application authentication unit 22, and the like described above in an information processing apparatus, such as a known personal computer and a workstation. Furthermore, the data server 3 can be implemented by installing the functions performed by the storing unit 31, the authentication unit 32, and the like described above in an information processing apparatus, such as a known personal computer and a workstation.

The components of each unit illustrated in the drawings are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the application authentication unit 22 and the token issuing unit 23 may also be integrated as a single unit. In contrast, the authentication unit 32 may also be separated by dividing it into a first authentication unit that authenticates the legitimacy of a user and a second authentication unit that authenticates an application authentication token. Furthermore, the storing unit 21 may also be an external device of the application server 2 and connected via a network.

According to an aspect of an embodiment of the data reference system disclosed in the present invention, it is possible to prevent authentication related information on an application from leaking into a data store location that is maliciously created.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data reference system comprising:
a first information processing apparatus; and
a second information processing apparatus, wherein
the first information processing apparatus includes
an authentication unit that authenticates, when an access is received that is made via an application, the legitimacy of the application on the basis of information related to the application, and
an issuing unit that issues, when the legitimacy of the application has been authenticated, signature information that includes processing unit information that indicates an information processing apparatus that stores therein data that is accessed by the application, and
the second information processing apparatus includes
a determining unit that determines, when an access that includes the signature information is received via the application, whether the processing unit information included in the signature information indicates the second information processing apparatus, and
a control unit that permits, when the processing unit information is associated with the second information processing apparatus, the application to access the data.

2. The data reference system according to claim 1, wherein
the issuing unit issues signature information that includes an access level that is defined by the information related to the application, and
the control unit permits the application to access the data in accordance with the access level included in the signature information.

3. The data reference system according to claim 1, wherein
the issuing unit issues signature information that includes the processing unit information that is specified by a user,
when the access that includes the signature information and user information that is related to the user is received via the application, the determining unit determines, on the basis of the signature information, whether the processing unit information included in the signature information indicates the second information processing apparatus,
when the processing unit information indicates the second information processing apparatus, the determining unit determines, on the basis of the user information, whether the user is legitimate, and
when the processing unit information indicates the second information processing apparatus and when the user is legitimate, the control unit permits the application to access the data.

4. The data reference system according to claim 1, wherein
the issuing unit issues signature information that includes the processing unit information specified by a user, and
when the access that includes only the signature information is received via the application, the determining unit determines, on the basis of the signature information, whether the processing unit information included in the signature information indicates the second information processing apparatus.

5. The data reference system according to claim 1, wherein
the issuing unit issues signature information that includes the processing unit information that is determined by the first information processing apparatus, and
when the access that includes only the signature information is received via the application, the determining unit determines, on the basis of the signature information, whether the processing unit information included in the signature information indicates the second information processing apparatus.

6. An application authentication method performed in a data reference system that includes a first information processing apparatus and a second information processing apparatus, the application authentication method comprising:
authenticating, performed by the first information processing apparatus, when an access is received that is made via an application, the legitimacy of the application on the basis of information related to the application;
issuing, performed by the first information processing apparatus, when the legitimacy of the application has been authenticated, signature information that includes processing unit information that indicates an information processing apparatus that stores therein data that is accessed by the application;
determining, when an access that includes the signature information is received and that is made via the application, performed by the second information processing apparatus, whether the processing unit information included in the signature information indicates the second information processing apparatus; and
permitting, performed by the second information processing apparatus, when the processing unit information is associated with the second information processing apparatus, the application to access the data.
